(19) United States
(12) Patent Application Publication
(10) Pub. No.: US 2018/0211491 A1
(43) Pub. Date: Jul. 26, 2018

(54) MULTI-PLAYER DICE GAMES

(71) Applicant: YAPPING MOOSE ENTERTAINMENT, INC., Kelowna (CA)

(72) Inventors: Ethan BURNSIDE, Kelowna (CA); Charissa BURNSIDE, Kelowna (CA)

(21) Appl. No.: 15/875,775

(22) Filed: Jan. 19, 2018

Related U.S. Application Data
(60) Provisional application No. 62/448,523, filed on Jan. 20, 2017.

(51) Int. Cl. G07F 17/32

(52) U.S. Cl. CPC G07F 17/3276; G07F 17/323

(57) ABSTRACT

Methods and systems are provided for implementing an online multi-player dice game. A game server creates a plurality of table rooms for each game, wherein one of the table rooms is designated as a head table room which directs the gameplay in the other table rooms by communicating signals to these rooms to activate and deactivate gameplay. The server also creates a game control room for managing communications between the head table room and the other table rooms and for managing the assignment of the players to the table rooms. The game server assigns the players to the table rooms in accordance with an algorithm based at least in part on the players' performance in previous rounds.

### REFERENCE TO RELATED APPLICATIONS

This application claims the benefit under 35 U.S.C. § 119 of U.S. Application No. 62/448,523 filed on 20 Jan. 2017 and entitled MULTI-PLAYER DICE GAMES, which is hereby incorporated by reference for all purposes.

### TECHNICAL FIELD

This invention relates to multi-player games. Particular embodiments relate to online or networked multi-player dice games.

### BACKGROUND

Online games can be played in one or more game rooms. Each game room is typically run independent of other game rooms. In particular, conventional online dice games are designed such that players are limited to interactions with other players who are also within the same game room. Players in different game rooms cannot interact with each other.

In the multi-table dice game of Bunco, each game is played over multiple rounds, with two to four players at each table. In some computer-implemented versions of the game, the total number of tables created for each game is fixed at three and thus the maximum number of active players for each game at any given time is twelve (assuming a maximum of four players at each table). One of the tables is the head table. The head table rings a bell to signal the start and stop of each round by all of the tables. New players can enter the game at any stage of the game play so long as an empty seat at a table becomes available; however, challenges may arise when the number of players that wishes to connect to a single game is greater than twelve. Thus, players may be waiting in a queue for a long time before a seat becomes available to play in a particular game. The long wait time would likely impact groups of players that are formed in sizes greater than twelve (since the maximum number of players for a single game is limited to twelve). Consequently, such sized group of players would not be able to play in the same game together. Because of various limitations of conventional online games, including those limitations described above with respect to conventional online dice games, there are challenges with using such technologies to implement multi-player multi-table games such as Bunco. In addition, there are particular challenges in regard to implementing a multi-player dice game such as Bunco for a large number of online players.

There is a general desire for technology that addresses and/or ameliorates at least some of the aforementioned problems or otherwise provides a gaming infrastructure which enables many players to play a single game of Bunco at the same time.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

Aspects of the technology provide for multi-player management systems and methods for implementing a multi-player dice game by one or more game servers connected to a plurality of client devices over a network, wherein each client device is associated with a player. The server transmits game instructions to a client device to enable the client device to access the game over the network. The server creates a plurality of table rooms running on the server for each game, wherein one of the table rooms is designated as a head table room. The server also creates a game control room running on the server for controlling the gameplay in the plurality of table rooms. The game control room running on the server assigns each player to one of the table rooms. The game control room relays a start signal received from the head table room to each of the other table rooms, wherein the start signal activates gameplay for a round. In addition, the game control room receives gameplay information from the head table room, and tracks the scores of the players in the head table room. The game control room communicates an end signal to each of the other table rooms if one of the players in the head table room reaches a threshold score, and/or if a predetermined time interval from the start time of the round has lapsed. The end signal deactivates gameplay for the round. In some embodiments, the game control room assigns players to table rooms in the next round, based on their performance in a previous round.

In other embodiments, a multi-player online dice game is implemented without the use of rooms such as game rooms or table rooms. For example, in these other embodiments, the players may be assigned to one of a plurality of game tables, wherein one of the game tables is designated as a head table, and the game application keeps track of which player is at which table (e.g. through the use of variables containing a value identifying the table associated with each player). The game round may be commenced by a start signal originating from the head table. The start signal may be activated upon a predetermined time period elapsing from the game start time or end time of the last round. The round may be ended by an end signal originating from the head table, wherein the end signal is activated by the earlier of: one of the players at the head table reaching a threshold score and the lapse of a predetermined time interval from the start of the round.

Particular embodiments of the technology are scalable to support a large number of players playing online networked games at different stages of play, wherein each game is played over multiple networked rooms under the control of a common game control room or a game server. At the end of each game and prior to the start of a new game, the multi-player management system causes all instances of existing table rooms for the game to be deleted and creates instances of new table rooms in sufficient number to accommodate the number of active players in the game room. In some embodiments, the number of active players in the game room is between 5,000 to 10,000. In some embodiments, the number of active players in the game room is between 200 to 400. In some embodiments, the number of active players in the game room is greater than 12. In some embodiments, the number of active players in the game room is between 13 and 500.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 illustrates a system and network environment for implementing a multi-player online dice game according to one example embodiment.

FIGS. 2 to 4 show various aspects of the game room architecture for implementing a multi-player online dice game according to an example embodiment.

FIG. 5 is a representation of a user interface showing a main lobby room of a multi-player dice game according to an example embodiment.

FIG. 6 illustrates a method for implementing a multi-player online dice game according to an example embodiment.

FIG. 7 is a representation of a gameplay user interface for a multi-player online dice game according to an example embodiment.

### DESCRIPTION

Throughout the following description, specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

This technology relates to computer systems and methods for implementing a multi-player game for players connected to one another via the Internet or other communication network. In particular embodiments, the game is played over a plurality of game rooms. Some game rooms may be defined in a parent-child relationship. For example, a head table room may exert control over one or more sub-table rooms. In particular embodiments the head table room communicates with the sub-table rooms to direct the gameplay (e.g. to start and stop play for each round). One or more higher-level control rooms may control the head and sub-table rooms. Some embodiments may be used to implement a video dice game, such as the dice game Bunco, or other casino-type games. In the multi-player dice game Bunco, which is played over multiple rounds, the players are grouped into tables and proceed through the rounds at the same time under the direction of a head table. Particular embodiments of the technology described herein can be used to enable several players, such as hundreds, or thousands of players, networked together online, to participate in the game of Bunco at the same time, wherein the players are distributed across several game tables, which are controlled by one or more head game tables. For each game, the tables go through multiple rounds of play with a synchronized start and stop of each round determined by the head game table. The players at each table take turns rolling dice to score points in accordance with the rules of the game. The tables may be ranked (with the head table receiving the highest rank), and between the rounds, players may move up or down a table rank, depending on their performance in the previous round. The game server(s) may support the play of games at more than one location, and each location may have more than one game being played.

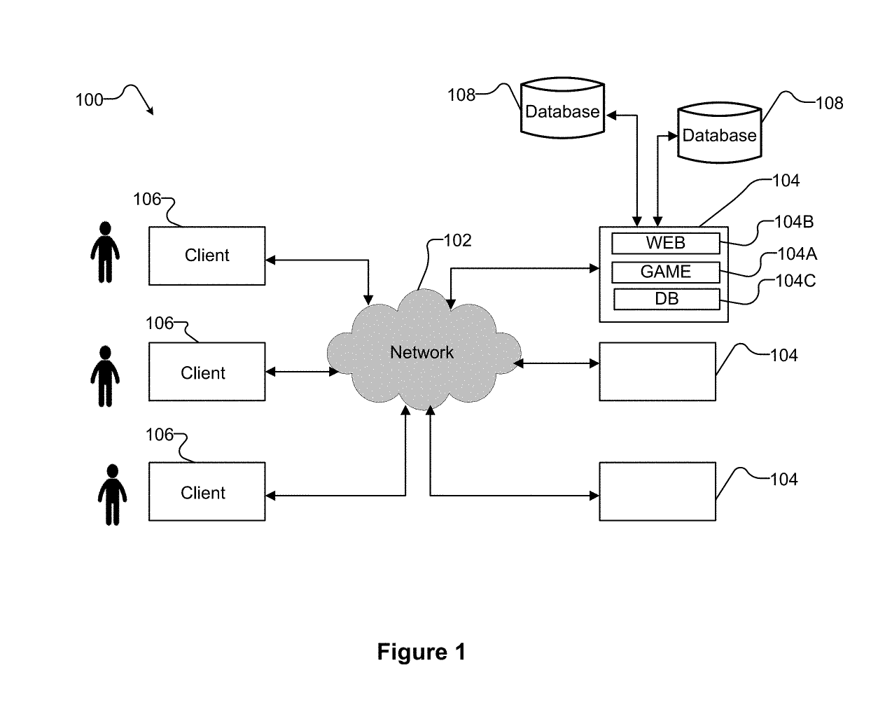

FIG. 1 illustrates a multi-player management system 100 according to an example embodiment for implementing a multi-player game. System 100 comprises one or more servers 104 (individually or collectively, server 104) which host games for a plurality of client devices 106 (also referred to herein as “clients”) operated by players of the game. Servers 104 and clients 106 are communicatively connected via a communications network 102. Clients 106 may also be in communication with one another via communications network 102. In particular embodiments, communications network 102 comprises the Internet. Each client 106 comprises an electronic device capable of connecting to communications network 102 and providing (via the device's display screen) a graphical user interface to enable the player to participate in the game. Such electronic device may comprise a desktop computer, a laptop, a set-top box, or a smartphone, tablet, personal digital assistant (PDA) or other handheld electronic device, or the like.

Each server 104 comprises a server system which is configured to host one or more games implemented in accordance with the embodiments described herein. The server system may have one or more game servers 104A comprising processors that run one or more game server applications. The game server 104A may provide software instructions that are executed by clients 106 for playing the game. The game software may be stored in a computer-readable medium (e.g. a memory, storage, or other media) associated with the game server 104A, and may be downloaded by the client 106 when the game is played. In some embodiments, game servers 104A are configured to run a multi-user socket server, such as, for example, SmartFoxServer™.

The server system also comprises one or more web servers 104B, which deliver web server content to a client 106 for playing the game. In particular, the game software may be made available to a client 106 from a website hosted by the web server 104B. The game may be accessed by launching a web browser in client 106 which connects the client 106 to the web server 104B to enable the client 106 to play the game in a window of the web browser.

The server system may also comprise a data server 104C that contains one or more databases 108 that stores gameplay records, player statistics, virtual inventory items, and other data related to the game.

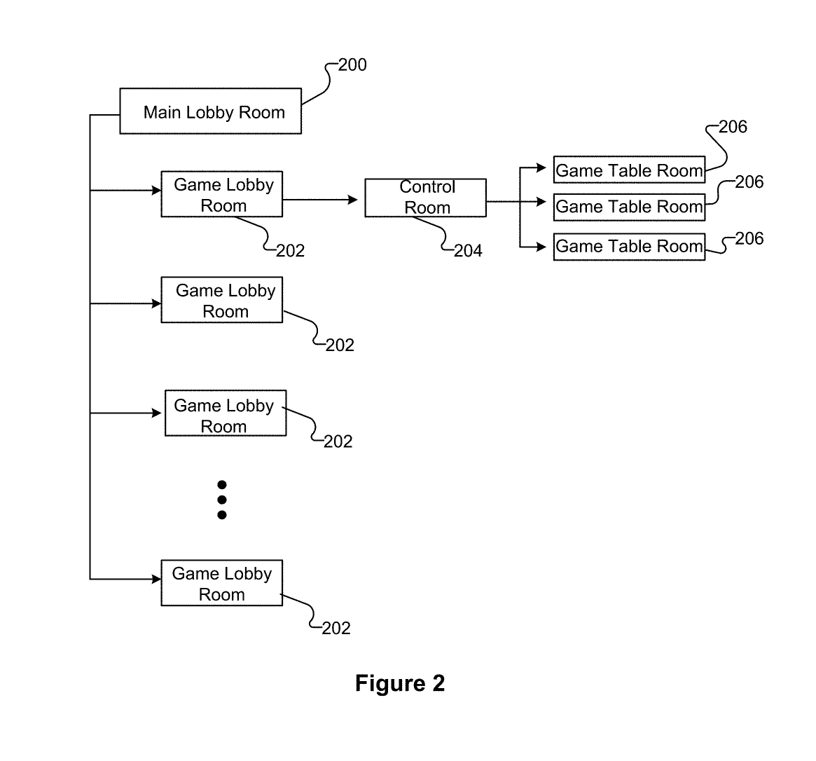

Referring to FIGS. 2 to 4, the game room architecture defines a plurality of virtual rooms comprising different room types such as, as seen in the illustrated embodiment, a main lobby room 200, game lobby room 202, game control room 204 and game table room 206. Each virtual room can be implemented as a room object by the game server application running on game server 104A. Unlike conventional dice games in which players enter a room and carry out the gameplay in the room independently of other rooms, the rooms in the illustrated embodiment are hierarchically organized and connected to and/or grouped with other rooms based on their relative rank and relationship to the other rooms. These rooms facilitate and manage the interactions between the players and tables and implement particular functions for a real-time, multi-player, multi-table online game such as for example synchronizing the gameplay of a plurality of sub-tables with a head table. The game room architecture enables a multi-player management system administered by game server 104B.

To start playing the game, a player connects their client 106 to server 104 over communications network 102, and loads or accesses the game on client 106. Upon loading the game, the player joins or enters the main lobby room 200. In embodiments where instances of a game are grouped by location, main lobby room 200 may be configured to provide a list of game locations for selection by the player. Locations may be defined as geographical locations, such as cities (Vancouver, Portland, San Francisco, etc.). However, it is not necessary that games be grouped by geographical location, and other embodiments may provide another manner for grouping instances of the game that is not by geographical location, or the games are defined to be in the same group or are not grouped at all. For each location or other grouping of games, game server 104A creates one or more game lobby rooms 202, control rooms 204, and game table rooms 206 (as seen in FIG. 2). In addition, main room 200 provides a chat interface which enables a player to chat with other players in the main lobby room 200 prior to the player selecting a game location.

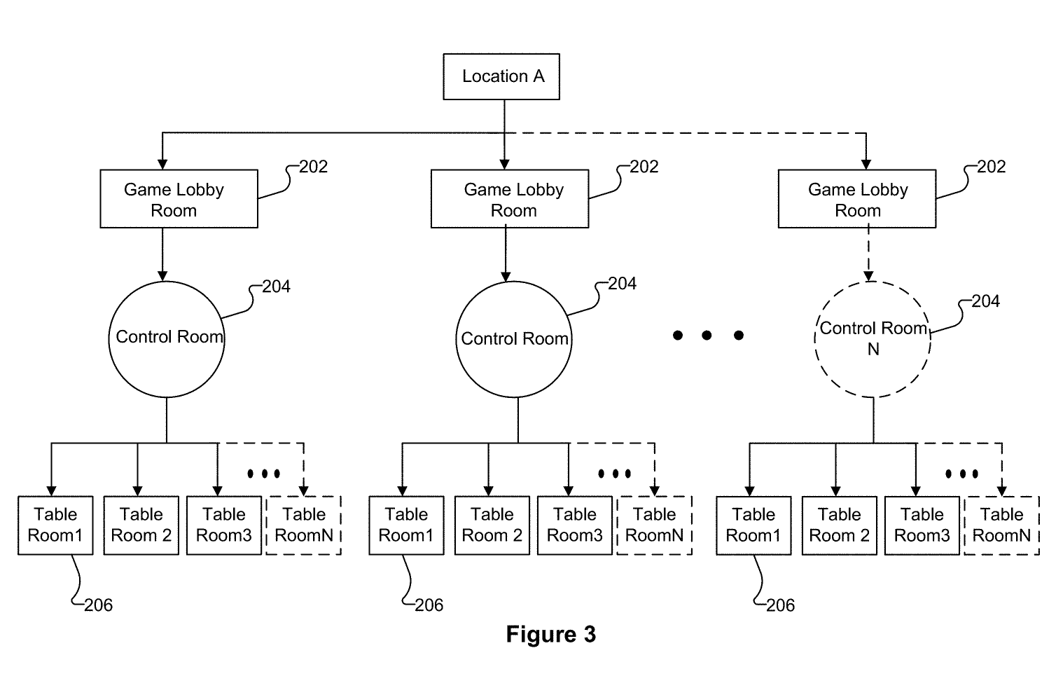

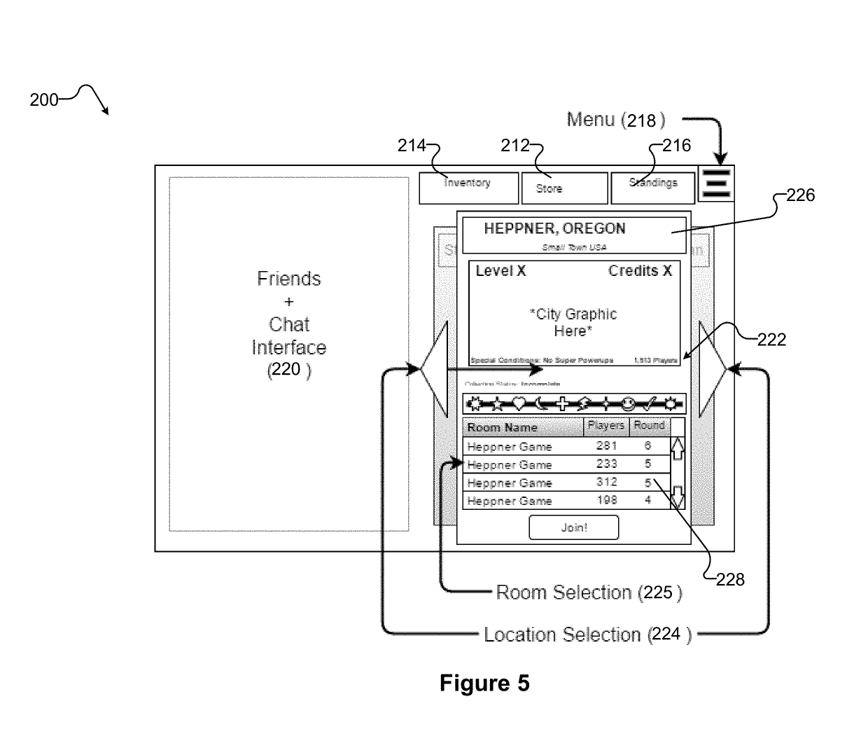

In the main lobby room 200, the player selects a game location (e.g. the selected game location seen in FIG. 5 is Heppner, Oreg.). After selecting a location, a list of games occurring in that location is displayed to the player wherein each of the games is associated with a game room. One instance of a game lobby room 202 may be created per game instance. There may be multiple games being played at a given game location, in which case multiple instances of a game lobby room 202 may be created per game location—i.e. one game lobby room 202 per instance of a game, as seen for Location A in FIG. 3. In some other cases however there may be only one game being played at a given game location. From the main lobby room 200, the player can view the list of games and select a game room (see FIG. 5), upon which the player joins game lobby room 202 for the selected game room. In the game lobby room 202, players wait to be assigned to a table and can observe other games in progress within the game room and interact with other players in the game, via an online chat interface for the game lobby room 202, for example. A player remains associated with their assigned game lobby room 202 until the player leaves the game. In some embodiments, before each game, the game server 104A may be configured to provide a preset time period (e.g., two minutes) for players to select a game lobby room 202. This preset time period may be referred to as the “pre-game buy-in period”. Players that select a particular game lobby room or otherwise indicate an interest in playing a game during this pre-game buy-in period would enter a queue to be included in the next game play in that game lobby room. In some embodiments, upon the expiration of the current pre-game buy-in period, a new game instance is created, and instances of game table rooms are created in sufficient number to accommodate all of the players who have joined the queue to play the game in the pre-game buy-in period. At the completion of that game, all of the instances of the game table rooms are deleted and the players are returned to the game lobby room for the pre-game buy-in period.

A player waiting in game lobby room 202 can be initially assigned to a table based on the player's selection or preference. Alternately, the player may be automatically assigned to a table based on a server-implemented algorithm which manages seating assignments for the players. When a spot opens up for a player at the table to which the player is to be assigned, the player joins a game control room 204 and game table room 206. Each instance of a game table room 206 represents one table and it may be occupied by two or more players (e.g. up to a maximum of 4 players in some embodiments). As there is generally more than one table for a game of Bunco, there can be multiple instances of a game table room 206, all participating in the same game under control of a common game control room 204. Each player remains associated with their assigned game control room 204 until they leave the game. However, the player may move between different game table rooms 206 between rounds of the same game.

In one particular embodiment, the code for creating a room object for an instance of a game table room 206, is as shown below:

```
private Room createGameTable(int id){
  String gameTableName = pRoomName+″_t″+id;
  Room tableRoom = null;
  tableRoom = RoomManager.createRoom(pZone, gameTableName,
    pRoomGroupName, pLocationName, Enums.ROOM_TYPE_
    GAMETABLE,
    DefaultGameSettings.TABLE_ROOM_CAPACITY,
    DefaultGameSettings.TABLE_ROOM_SPECTATORS);
  if (tableRoom == null) {
    trace(″Error creating gameTable, room is null″);
  }else{
    pTableRoomList.add(tableRoom);
    pNumGameTables = pTableRoomList.size( );
    SFSObject params = new SFSObject( );
    params.putInt(Enums.ID, id);
    params.putInt(Enums.GAMEROOM_ROOM_ID, pRoomId);
    ISFSExtension ext = tableRoom.getExtension( );
    ext.handleInternalMessage(Enums.INTERNAL_INIT, params);
  }
  return(tableRoom);
}
```

Game control room 204 serves as the master controller for an instance of a game. In particular, game control room 204 may control and manage the movement of players between the game table rooms 206 (i.e. between the tables in the game room). Game control room 204 may also manage and relay communications sent between game table rooms 206. Game control room 204 and/or game table rooms 206 may receive and process user input provided at clients 106, cause the execution of game logic to enable players to perform certain game actions (e.g. roll the dice when their turn is active) and update the game state accordingly (e.g. tally the score for the players), transmit the updated game state back to client 106 for viewing at the graphical user interface on client 106, and relay messages between the head table and sub-tables in order to synchronize the gameplay of the sub-tables with the head table (as described herein).

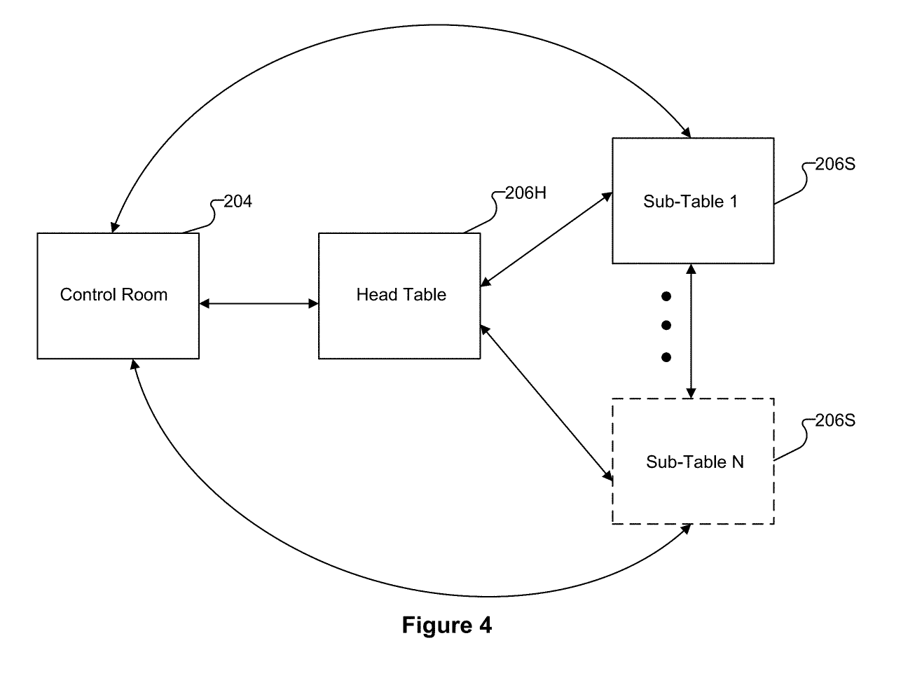

As seen in FIG. 4, one game table room 206 within a game room (i.e. associated with a game control room 204) may be designated as a head table room 206H. Game table rooms 206 other than head table room 206H can be referred to as sub-table rooms 206S. Head table room 206H is configured to be in control of the gameplay (and therefore, in control of the sub-table rooms 206S) throughout the duration of a game. In other words, clients 106 connected to the head table room 206H control the progress of the gameplay of all of the other tables (i.e. in the sub-table rooms 206S). In some embodiments, head table room 206H communicates with each of sub-table rooms 206S during the game in order to tell the players at the other tables to start or stop playing the round.

The relationships and flow of communications between game control room 204, head table room 206H and sub-table rooms 206S during a gameplay is shown in FIG. 4. Rooms 204, 206H and 206S may be defined by a hierarchical relationship. In the illustrated embodiment, control room 204 is configured to exert control over head table room 206H and sub-table rooms 206S. Head table room 206H is configured to exert control over sub-table rooms 206S.

In particular embodiments, head table room 206H communicates with each of sub-table rooms 206S via game control room 204. The logic for the gameplay processes may be designed such that head table room 206H communicates start signals and end signals to game control room 204, wherein the start signal signifies the start of a round and the end signal signifies the end of a round. Game control room 204 then transmits the start/end signals to each of sub-table rooms 206S. The rounds of play in each of head table room 206H and each of sub-table rooms 206S thus start and end at the same time as dictated by head table room 206H.

In some embodiments, a countdown timer may be initiated at the beginning of a round. At the expiration of the countdown timer, a start signal for the round may be transmitted to game control room 204. A start signal for the round may also be triggered when the players in the head table room 206H signify that they are ready to commence the round. For example, one of the players at the head table may ring a bell to signify the start of a round. An end signal that ends the round may be triggered by one or more events occurring in the head table room 206H. For example, an end signal may be sent to game control room 204 upon the earlier of: a certain score being accumulated by one of the players in head table room 206H; and the expiration of a predefined time interval. Upon receipt of each start or end signal from head table room 206H, control room 204 transmits such signal to each of sub-table room 206S. Gameplay for each round in any of the table rooms 206 starts and ends upon receiving the start and end signals, respectively, or upon receiving notification from head table room 206H corresponding to the start and end of the round.

Each game table room 206 may also be configured to provide a chat interface so that players at the same table (i.e. clients 106 that have joined a particular game table room 206) may send messages to one another during the game. In particular embodiments, messages may also be sent between players at different tables (e.g. between head table room 206H and any of sub-table rooms 206S or between sub-table rooms 206S).

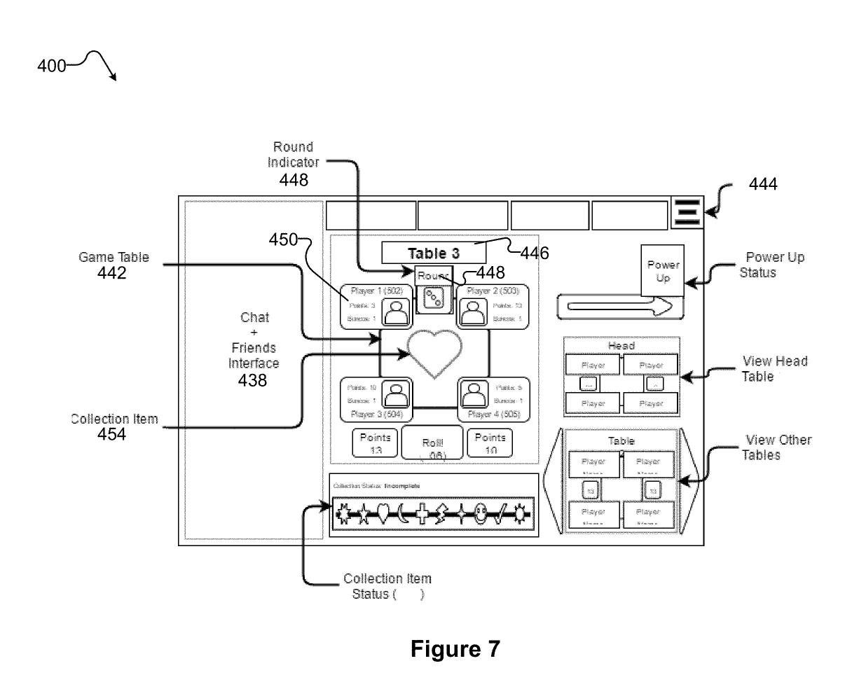

Communications, including game-related communications and chat communications, may be sent by players between game table rooms 206 using control room 204 as an intermediary. For example, a player at the head table in head table room 206H may relay through the chat interface a chat message to players of all of the sub-table rooms 206S. The message is transmitted to game control room 204 which then transmits the message to the clients 106 associated with the other sub-table rooms 206H. The message may be displayed on a chat interface that is visible to all users connected to server 104 (e.g., chat interface 438 shown in FIG. 7). Alternatively or additionally, messages may be sent to individual users in private chatroom. Such messages may be visible only to the selected recipient.

As noted above, in addition to acting as the intermediary for sending communications between game table rooms 206, game control room 204 may be configured to group the players by table and manage the assignment or connection of players to game table rooms 206, which may include moving players to a different game table room 206 in between rounds. Each table room 206 associated with a game control room 204 may be ranked relative to one another. In particular embodiments, head table room 206H is assigned as the highest ranking game table room 206 (e.g. rank 1) and sub-game rooms 206S are assigned to a lower rank (e.g. rank 2, 3, 4, etc.). The game table room 206 to which a player is assigned may be based on the player's performance in previous rounds or a previous game, and/or the amount of virtual coins the particular player pays to play the particular game, and/or other factors. In some embodiments, the game table room 206 to which a player is assigned initially for the first round of a new game depends on whether the player is a returning player or a new player to the game. Returning players may be given priority over new players. For example, returning players may be first to be assigned to the game table rooms 206. The game table rooms 206 in which such returning players are placed may be based on the ranking associated with the game table room 206 in which such players were playing in the previous round and/or such players' performances in the previous game. New players may be assigned to the remaining table rooms 206 based on the order in which they enter the game control room 204.

Each game control room 204 may be configured to communicate with game table rooms 206 and its connected game lobby room 202, and to process the information received from rooms 206 and 202 in order to manage the assignment of players to the tables (i.e. by determining which game table room 206 a client 106 should join). A player can select a particular game location and game room to enter by providing input at the graphical user interface running on their client 106. First, client 106 communicates to main lobby room 200 a particular location selection. Upon receipt of the location selection, game control room 204 presents a list of active games to a client 106. The player selects a game, which associates or connects the player with a game lobby room 202 for that game. The game lobby room 202 communicates to the game control room 204 that a new user has entered the game lobby room 202. Prior to the start of a game, in some embodiments the game control room 204 may group the active players in the game room into teams of a predefined number (e.g. teams of 2 players). Game control room 204 allocates the players to game table rooms 206. Each player connects with and joins their assigned game table room 206. In particular embodiments, in order to ensure that all game table rooms 206 have the same number of players, game control room 204 may be configured to add bot players (e.g., players controlled by a computer program) into one or more game table rooms 206 in which there is a deficit of real-life user. Where the players are grouped into teams (e.g. teams of 2 players), the team groupings may vary for each round, and, depending on the performance of each player in a round, the player may have different teammate(s) in the next round. In other embodiments, the players may remain in the same team groupings throughout a game.

Game table rooms 206 may be configured to transmit information about the players' performance to game control room 204. Such information may be used for purposes of allocating players to a game table room 206 in the subsequent round of a game (where the game comprises a plurality of game rounds) or in the next game. For example, in some embodiments, game table rooms 206 transmit to control room 204 the points scored by the players. After the end of each round of a game, game control room 204 processes the scores and, based at least on the points scored, assigns the players to a particular game table room 206 in the next round.

The number of rooms 202, 204 and 206 that are available at a given time may depend on a plurality of factors such as the number of active users and the number of active games at a given time. Server 104 can create or delete instances of rooms 202, 204 and 206 at any time to accommodate an increase or decrease in the number of active users, as the case may be. For example, in some embodiments, at the end of each game, and prior to the start of the next game, server 104 deletes all existing instances of table rooms 206 and creates a sufficient number of new instances of table rooms 206 in order to accommodate the number of players waiting to join the game from game lobby room 202.

FIG. 5 illustrates a representation of a graphical user interface 200 for playing an online dice game according to one embodiment. When the player loads the game on client 106, the player joins main lobby room 200. In the illustrated embodiment, main lobby room 200 serves as a portal for accessing various features of the online dice game (as described below). For example, main lobby room 200 may include a chat interface 220. Chat interface 220 allows players who have connected to the game application via clients 106 to exchange messages with one another. The chat capability provided by chat interface 220 may be useful for a number of purposes, including enabling the players to coordinate selection of a common game room where they can play together.

In some embodiments, the dice game is played with virtual cash. The virtual cash may be purchased with real cash, and may be won or lost while playing the dice game. A predetermined amount of virtual cash may be collected from each player before each new round or game. The virtual cash may also be utilized to buy items in an online store 212 (which can be accessed through main lobby room 200). The amount of virtual cash available for playing may be viewed in inventory area 214.

Players collect points as the dice game progresses. The cumulative points scored by each player and the computed standings of the players based on such points may be displayed within standing area 216 of the graphical user interface 200 (see FIG. 5). Menu area 218 may give players the option to manage the player's profile, buy virtual cash with real currency, and other related functions.

A game selection area 222 may be provided in the graphical user interface 200, to present the player with options for their selection of a location and/or game room to play in. In the illustrated embodiment, game selection area 222 includes a location selection menu 224 and a game room selection menu 225. The location selection menu 224 lists all of the available locations 226 that have games available for players to play in at the particular time. The available locations 226 may be a list of different geographical locations. For example, in the illustrated embodiment, Heppner, Oreg. is the selected location. After the player makes a selection of a location 226, a list of game rooms that are available within the selected location is presented to the player in room selection menu 225. Each game room corresponds to one game lobby room 202.

In some embodiments, main lobby room 200 provides information about games in progress in the graphical user interface of each connected client 106. Such information may include, for example, the current round being played in the game, the scores of the players, and the estimated remaining time in the game. In particular embodiments, new players cannot join the game room while the game is in progress. Players can decide which of the games to join based on the estimated remaining times. One advantage of providing multiple game rooms, at different stages of play, is it provides the ability to accommodate different locations and time zones. Another advantage is that the server 104 can scale up or scale down the game to create enough rooms to support the number of active players at any particular time. The initiation of staggered games across different game rooms may be based on an algorithm which minimizes the wait times players must wait in between joining games. The server 104 may allow for more game rooms to be created at peak times when more players are active.

In some embodiments, a player can choose to connect to a game lobby room 202 as an observer to that game rather than as a player. In that case, client 106 receives from server 104 the updated game state information but does not transmit any game input to server 104. Progress of the active games can be displayed to the observer on the graphical user interface of client 106.

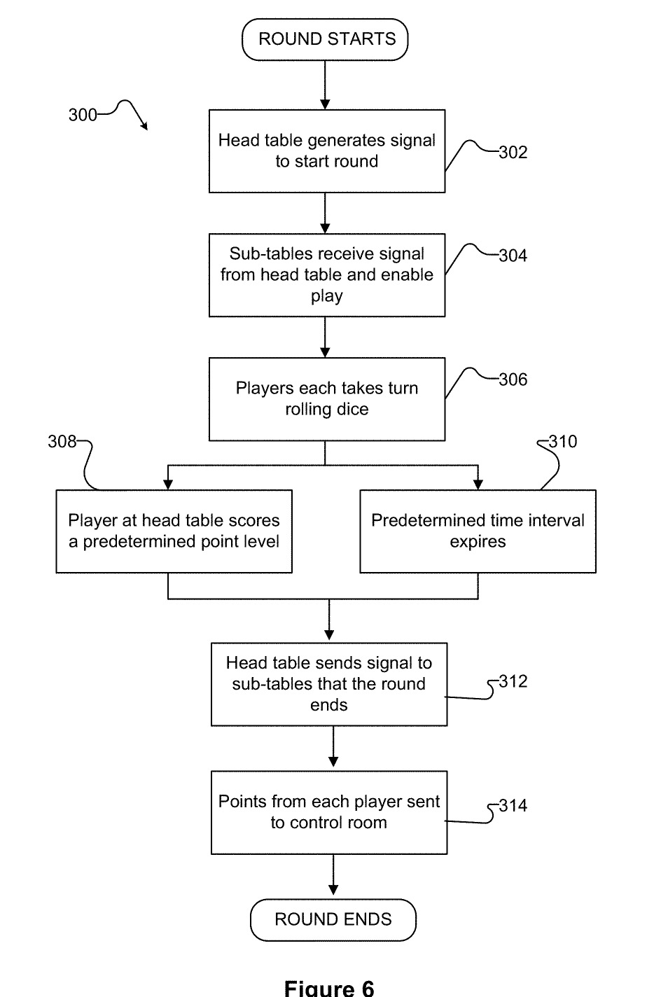

FIG. 6 is a flowchart of an exemplary method 300 of implementing one round of an online multi-player dice game. When the players at the head table (i.e. in head table room 206H) are ready to begin a round of a game, the head table room 206H sends a communication to each of the sub-table rooms 206S signifying the start of the round (blocks 302 and 304). In some embodiments, a ready button or bell may be presented to each of the players at head table 206H on the user interface of their client 106 and the players at head table 206H are asked to press the button or ring the bell when they are ready to begin the round. The round commences upon receiving at the server a message from the players at the head table that they are ready to play the game. In some embodiments, head table room 206H transmits a start signal to game control room 204 when a predetermined time interval from the end of a previous round has lapsed (e.g., the start signal may be sent at the expiry of a countdown timer, without any further input from the players at the head table). In response, the game control room 204 may communicate the start signal to the other table rooms 206S to activate game play. In some embodiments, the start signal may be transmitted from the game control room 204 to sub-table rooms 206S to activate game play for the round in response to a first player at head table room 206H rolling the dice.

At block 306, once the round begins, each of the players at the head game table and sub-game tables takes turns rolling one or more dice. In certain embodiments for the game Bunco, each player takes turn rolling three dice and attempts to roll the same number as the number of the round. For example, if it is round 2, each player attempts to roll one or more 2's during that round. A player scores points for every number rolled that matches the number of the round. When it is their turn to roll the dice the player may press a button representation on the user interface of their client device 106 to activate the dice roll. In response to receiving the dice roll activation from the client device 106, a graphical representation of the dice roll and result (number) for the dice roll is displayed on the user interface. The result may be computed using a random number generator executed by the game server 104B

In particular embodiments, the round terminates upon the earlier of the expiry of a predetermined time interval 310 and a predetermined cumulative score reached by the players at head table room 206H (e.g. when the head table has earned 21 points). In particular embodiments, the head table room 206H controls a timer that is set for a predetermined maximum time for each round. As soon as the predetermined time has expired according to the timer, or as soon as the players at head table have accumulated the predetermined number of points (whichever occurs first), head table room 206H notifies each sub-table room 206S of the termination of the round (at block 312). In particular embodiments, the head table room 206H sends an end signal or message to the game control room 204 to terminate the game upon one of the above events occurring. Game control room 204 then iterates through the list of table rooms 206, relaying a round termination message or end signal to each table. The termination message can also communicate the number for the next round so that the other tables know what round should be played next. By ensuring that each round does not extend past a predetermined time interval (e.g. by ending the round upon the earlier of: (i) the expiration of a time interval and (ii) the players at the head table accumulating a certain number of points), reasonable constraints are put on the overall length (duration) of the game. This feature facilitates the participation of a large number of players in the game, since the length of each round will generally increase with an increase in the number of players playing (since players get further rolls of the dice as long as they keep scoring points) unless a time limit is placed on each round. In particular embodiments, each game finishes after 6 rounds have been played. After the maximum number of rounds in the game has been played and the last round has ended, control room 204 running on game server 104B communicates an end of game message to each of the table rooms 206 to deactivate gameplay.

The manner in which points are scored varies from game to game. In some implementations of the dice game of Bunco, a team consisting of two players at head table 206H (corresponding to two users on two clients assigned to head table room 206H) wins the round (and thus triggers a termination of the round) if the team scores a total of 21 points or has rolled a “Bunco” (which is equivalent to scoring 21 points). A player has rolled a Bunco when he or she has rolled three dice of the same number as the number for the round the game is currently in (e.g., in round 1, a Bunco is rolled when someone rolls three 1's and in round 2, a Bunco is rolled when someone rolls three 2's). A player or team of players can score points even if a Bunco has not been rolled. For example, in certain embodiments, points may be scored in cases where one or two out of the three dice rolled is the number corresponding to the round the game is currently in or when three of a kind is rolled.

Head table rooms 206H and each of sub-table rooms 206S are configured to keep track of and record the number of points scored by the players at their respective tables after each player rolls the dice. The cumulative points scored by players in head table room 206H can trigger the termination of a round as explained above.

Code for implementing the game round decisions and communications by the head table according to one embodiment is shown below:

```
// Game Room Table #1
// 21 has been reached at head table, increment the rounds
up until round 6 is reached
private void ht_sendRoundBell(int winType){
  if (pIsHeadTable){ // if we’re at Game Room Table #1
  (remember, table code is
    shared with all tables.)
    pGameRound++; // increment the round counter
    pRollTurn = 0;
    if (pGameRound<1){
      pGameRound = 1;
    }
    if (pGameRound> pMaxRounds){
      gameComplete( );
    }else{
      SFSObject params = new SFSObject( );
      params.putInt(Enums.ROUND, pGameRound);
      // set the round to a variable
      params.putInt(Enums.TYPE, winType);
      ht_sendCommandToAllTables(Enums.INTERNAL_
      RING_ROUND_BELL,
    params); // f(x) for table data relay thru parent Game Room
      ht_startWaitForRoundBellComplete( );
    }
  }
}
```

In some embodiments, the players at each game table are organized by teams (e.g. teams of 2, with two teams sitting at each table). The players thus score points in teams. In such embodiments, the round is terminated when a team at head table 206H scores a Bunco or a predetermined number of points or when the time for the round expires (whichever occurs first).

Referring to block 314, at the end of each round, points scored by all of the players are transmitted from head table room 206H and each of the sub-table rooms 206S to control room 204. Based on the points scored by the players, game control room 204 allocates the players into one of table rooms 206 for the next round (and thus connects the clients 106 to their assigned table room 206). The game table room 206 to which the players are assigned in subsequent round(s) may be based on the players' performance in the preceding round. In particular embodiments, the winning player(s) connected to each sub-table 206S (e.g., the players that scored the highest number of points) may be moved to a higher ranking table in the subsequent round while the losing player(s) connected to each sub-table room 206S (e.g., the players that scored the lowest number of points) may be moved to a lower ranking table in the subsequent round. The winning player(s) connected to head table room 206H may remain connected to head table room 206H, while the losing player(s) previously connected to head table room 206H may be connected to the next highest ranked sub-table room 206S. The losing player(s) connected to the lowest ranked sub-table room 206S may remain connected to the same lowest ranked sub-table room 206S.

In the embodiments in which the players are grouped into teams, the players on the same team may be assigned to the same game table room 206 together in subsequent rounds until the game ends. In other embodiments the players may be grouped with different teammates for subsequent rounds, depending on their performance in the earlier round. Game control room 204 may be configured to group the players in teams of a predefined number (e.g., teams of two in the game of Bunco) in the beginning of each game (and each round). The clients 106 operated by players that are assigned to be on a team may be flagged to be linked together by game control room 204 for the duration of the round.

At the end of each round of a game, game control room 204 receives the points scored by the players in each table room 206 and for each player, increments the player's tally by the score achieved for that round. The score may be transmitted to server 104C which stores the value of the scores for each player in database 108. The stored scores may be used for one or more of the following: determining the assignment of game table rooms 204 of each player at the end of each round or game; allocating awards at the end of each game; and recording the cumulative scores achieved by each player from all of the games that were played using system 100.

After the last round has been played in a game, players may choose to remain in the same game room (i.e., remain connected to the particular game lobby room 202), return to main game lobby 200 to select a different game lobby room 202 to play in, or exit the game application. If a player chooses to remain connected to the same game lobby room 202, the player may, during the pre-game buy-in period, make a selection to remain in the same game lobby room 202 or indicate a preference to play in the next game associated with the game lobby room 202. Upon receiving such a selection, game control room 204 assigns the client 106 to a table room 206 for the first round of the next game.

Code for implementing some of the game control functions described herein by the game control room 204, in accordance with one embodiment, is shown below:

```
// Game Room code to handle incoming messages
  public Object handleInternalMessage(String cmd,
  Object params){
    switch (cmd){
    case Enums.USER_JOINS:
      userJoins(params);
      break;
    case Enums.USER_LEAVES:
      userLeaves(params);
      break;
    case Enums.INTERNAL_START_GAME:
      //deleteOverflowTables( );
      sendCommandToAllTables(cmd, (SFSObject)params);
      break;
    case Enums.INTERNAL_JOIN_GAME_TABLE:
      requestJoinTable((SFSObject)params);
      break;
    case Enums.INTERNAL_RING_ROUND_BELL:
    // this is triggered for the
      incoming round bell message
      SFSObject params2 = (SFSObject)params;
      params2.putInt(Enums.TOTAL_NUMBER_OF_
      TABLES, pNumGameTables);
      sendCommandToAllTables(cmd, params2); //
      which calls this function to relay
      the message back out to ALL tables
      break;
    case Enums.INTERNAL_CHANGE_TABLES:
      movePlayersToTables( );
      break;
    case Enums.INTERNAL_CHANGE_TABLE_COMPLETE:
      sendCommandToAllTables(cmd, (SFSObject)params);
      break;
    case Enums.INTERNAL_HEAD_TABLE_SCORES:
      sendCommandToAllTables(cmd, (SFSObject)params);
      break;
    }
    return(null);
```

In some alternate embodiments, the game is not played over a plurality of game rooms. For example, certain embodiments are implemented without a game control room controlling the game play over multiple rooms. A gaming architecture different from that shown in FIGS. 2 to 4 may be used to implement such a game. The server may be configured to attach variables to every player connected to the game. Such variables may contain gameplay information specific to each player, such as, for example, the player's game table assignment for a round of the game. Such variables may be updated by the server in accordance with the game play (e.g., the variable for the player's game table assignment may be updated for each subsequent round as the players are assigned to a different game table based on their performance from a previous round). The server is in communication with the client devices throughout the game to direct game play.

FIG. 7 is a representation of a graphical user interface showing a gameplay interface for playing a dice game according to an example embodiment. Gameplay interface 440 may be displayed at client 106. Gameplay interface 440 comprises a chat interface 438 (as discussed above), gameplay information 442, in-game menu 444, and other gameplay features.

In the illustrated embodiment, gameplay information 442 includes a table indicator 446 (e.g., the table room 206 in which the player is currently connected to), a round indicator 448 (e.g., the round in which the game is currently at), player information 450, and one or more virtual dice which may be in the form of a “roll!” button 452 as shown in the illustrated embodiment. In some embodiments, the player has the option of choosing how the roll of the dice will be displayed. For example, the player may have different roll options to select from (e.g., classic roll, twist and tumble dice, shake dice). Button 452 displayed at the interface of each client 106 may become active upon receiving from server 104 a signal of the particular player's turn to roll the dice.

Player information 450 may include information about the players that are playing at the same table as well as information about players that are at the other tables (i.e. in other game table rooms 206 connected with the same game lobby room 202). Player information 450 includes player profile information (e.g., profile photo and username of the players), total points scored by each player in the current round, and in the embodiment in which the dice game is bunco, the number of “buncos” that have been scored by each player in the current round.

Other gameplay features may be implemented to further engage the players. One such feature is directed to in-game collectables 454 (see FIG. 7). Collectables 454 may be collected during the game as they appear randomly on the gameplay interface 440. In particular embodiments, collectables 454 may be available to the player when a particular combination of the dice is rolled. In the game of Bunco, for example, collectables 454 may also be available when the player rolls a “Bunco”. Collectables 454 may be shown on the gameplay interface 440 when server 104 determines that a particular player has won a collectable item 454. Collectables 454 may be used to exchange virtual inventory items that can be used towards future game play (for example, bonus or additional rolls, winning double/triple points in a round, and the like). Players may collect unique collectables 454 available only in certain locations. Other forms of rewards such as “power-ups” may also be provided. “Power-ups” is a bonus gameplay feature to make the game more interesting for players. Some bonus features that may be available to the players include the ability to earn more points, trigger an extra dice in the roll, introduce wild card dice, and the like.

Particular embodiments of this invention are directed to computer-implemented methods and systems for playing the game of Bunco over a communications network wherein the methods and systems are scalable to support a large number of players. Whereas conventional games limit the number of players for each game to 12 players, the game infrastructure described herein enables the game of Bunco to be played in conjunction with more than 12 players. Particular embodiments permit hundreds or thousands of players at once to play the game, with one head table, generally having four players, directing the game play. As described herein, features which facilitate the scalability of the game to large numbers of players include, but are not limited to: transmission of an end of round signal or message upon the expiration of a countdown timer (lapse of a predetermined interval) thus limiting the duration of each round; a game control room which manages the game play over the multiple rooms and assigns the players to the tables in accordance with the methods described herein and coordinates communications and game play directions (such as the start round signal and end round signal) between the head table and the sub tables.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a computer system for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Embodiments of the invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

The invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, server, client, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

While a number of exemplary aspects and embodiments have been discussed above, those of skill in the art will recognize certain modifications, permutations, additions and subcombinations thereof. For example:
The server system may provide an application programming interface (API) to enable players' access to the game using game software on other servers or other client devices 106.
One or more of the rooms may be omitted in alternate embodiments. For example, some embodiments provide main lobby room 200, game control rooms 204 and game table rooms 206, but without game lobby rooms 202. Functionality provided by game lobby room 202 may be provided instead by one of the other rooms. In still other embodiments, rather than using game rooms, variables are assigned to the players as described above in order to facilitate game play over multiple tables.
In an alternate embodiment, all game table rooms 206 send their scores to the game control room 204, and some or all of the logic for the start of round, end of round, player table movement, score updates, etc., may be controlled by the game control room 204 based on data coming from the head table rather than being managed by the head table.
In an alternate embodiment, all the players join a game room and tables are implemented by tracking and sending out per table assignments for display in the game client rather than utilizing game table rooms. Per table chat filters in that scenario could also be implemented at the game room level to achieve the function of chatting with other players at one's table.
In the above-described embodiments, the game server may be implemented using a multi-user socket server such as SmartFoxServer™. In other embodiments, alternate server technology, such as Node.js, may be used to implement the same or similar logical structures and/or logical play mechanics as described above.
Variations of the game may include having more or less dice being rolled per turn, providing dice with more or less sides, and/or games with more or less rounds.
In alternate embodiments, players do not join a room as observers but the game provides other ways for the players to join games such as providing ways to obtain payment before the player is able to access the game.
In some embodiments, additional game features such as collection items, charms, chat, experience, avatars, levels, power ups, etc. can be incorporated. One or more collection item may be placed on the game table for players to win. One example is when a collection item or any one of the above game features is being awarded to the first player who scores a Bunco.
In some embodiments, alternate zones for the game may be implemented by the game server.
   As such, the scope of the claims should not be limited by the preferred embodiments set forth in the examples, but should be given the broadest interpretation consistent with the description as a whole.

What is claimed is:

1. A method for implementing a multi-player dice game by a game server connected to a network, the method comprising:
transmitting, by the server, game instructions to a client device connected to the network to enable the client device to access the game over the network, wherein the client device is associated with a player;
creating, by the server, a plurality of table rooms running on the server for a game room, wherein one of the table rooms is designated as a head table room;
creating a game control room running on the server for controlling the gameplay in the plurality of table rooms;
receiving, at the server, a selection of the game room from the client device;
selecting, by the server, one of the table rooms for the player to join, and assigning the player to the selected table room;
receiving, at the game control room running on the server, a start signal from the head table room; and
communicating, by the game control room running on the server, the start signal to each of the other table rooms, wherein the start signal activates gameplay for a round.

2. The method according to claim 1 comprising receiving, at the game control room running on the server, gameplay information from the head table room, and in response to receiving the gameplay information, determining scores of the players in the head table room based on the gameplay information and communicating an end signal to each of the other table rooms if a cumulative score of the players in the head table room reaches a threshold value, wherein the end signal deactivates gameplay for the round.

3. The method according to claim 2 wherein the game control room communicates the end signal to each of the table rooms if a predetermined time interval from the start time of the round has lapsed.

4. The method according to claim 3 wherein the table rooms are ranked, and the method comprises receiving, at the game control room running on the server, gameplay information from the plurality of table rooms at the end of each round, and in response to receiving the gameplay information, determining a score of each player for the round and ranking the players at each table based on their score in the round, and moving at least some of the players in each table room up or down a relative rank in table based on the player's ranking.

5. The method according to claim 1 wherein the game control room allocates four players to each table room.

6. The method according to claim 1 wherein, at the end of each game and prior to the start of a new game, the method comprises deleting, by the server, all instances of existing table rooms and creating, by the server, instances of new table rooms in sufficient number to accommodate the number of active players in the game room.

7. The method according to claim 1 wherein the server and the client device are connected via the Internet.

8. The method according to claim 7 wherein the client device is a desktop computer, a laptop, a set-top box, a smartphone, a tablet, personal digital assistant (PDA) and/or other handheld electronic device.

9. The method according to claim 1 to comprising creating, by the server, a main lobby room, and wherein each player joins the main lobby room upon connecting their client device to the server and selects a game to join from the main lobby room.

10. The method according to claim 1 to wherein the start signal from the head table room is generated when a player in the head table room performs an action to signify a start of the round.

11. A method for implementing a plurality of multi-player dice games by one or more game servers connected to a network, wherein each one of the plurality of multi-player dice games is implemented in accordance with method 1.

12. The method according to claim 6 wherein the number of active players in the game room is greater than 12.

13. The method according to claim 12, wherein the number of active players in the game room is between 13 and 500.

14. A multi-player management system for implementing a multi-player dice game, comprising a game server connected to a network, the server configured to:
transmit game instructions to a client device connected to the network to enable the client device to access the game over the network, wherein the client device is associated with a player;
create a plurality of table rooms running on the server for a game room, wherein one of the table rooms is designated as a head table room;
create a game control room running on the server for controlling the gameplay in the plurality of table rooms;
receive a selection of the game room from the client device;
assign the player to one of the table rooms;
receive at the game control room running on the server, a start signal from the head table room; and
in response to receiving the start signal, cause the game control room running on the server to communicate the start signal to each of the other table rooms, wherein the start signal activates gameplay for a round.

15. The system according to claim 14 wherein the server is configured to receive, at the game control room running on the server, gameplay information from the head table room, and in response to receiving the gameplay information, the server determines scores of the players in the head table room based on the gameplay information and communicates an end signal to each of the other table rooms if a cumulative score of the players in the head table room reaches a threshold value, wherein the end signal deactivates gameplay for the round.

16. The system according to claim 15 wherein the server is configured to communicate the end signal to each of the table rooms if a predetermined time interval from the start time of the round has lapsed.

17. The system according to claim 16 wherein the table rooms are ranked, and the server is configured to receive, at the game control room running on the server, gameplay information from the plurality of table rooms at the end of each round, and in response to receiving the gameplay information, is configured to determine a score of each player for the round and rank the players at each table based on their score in the round, and move at least some of the players in each table room up or down a relative rank in table based on the player's ranking.

18. The system according to claim 14 wherein the server is configured to allocate four players to each table room.

19. The system according to claim 14 wherein, at the end of each game and prior to the start of a new game, the server is configured to delete all instances of existing table rooms and create instances of new table rooms in sufficient number to accommodate the number of active players in the game room.

20. The system according to claim 14 wherein the server and the client device are connected via the Internet.

21. The system according to claim 20 wherein the client device is a desktop computer, a laptop, a set-top box, a smartphone, a tablet, personal digital assistant (PDA) and/or other handheld electronic device.

22. The system according to claim 14 wherein the server is configured to create a main lobby room, and wherein each player joins the main lobby room upon connecting their client device to the server and selects a game to join from the main lobby room.

23. A system for implementing a plurality of multi-player dice games, comprising at least one game server connected to a network, wherein each one of the plurality of multi-player dice games is implemented by one of the at least one game servers which is configured in accordance with claim 14.

24. The system according to claim 19 wherein the number of active players in the game room is greater than 12.

25. The system according to claim 24 wherein the number of active players in the game room is between 12 to 500.

26. A networked game system comprising a plurality of multi-player management systems in accordance with claim 14.

27. A multi-player management system configured to perform a method according to claim 1.

28. A method for implementing a multi-player dice game by a game server connected to a network, the method comprising:
transmitting, by the server, game instructions to a client device connected to a network to enable the client device to access the game over the network, wherein the client device is associated with a player;
creating, by the server, a plurality of game tables running on the server, wherein one of the game tables is designated as a head table and wherein the plurality of game tables is associated with an instance of a game instance;
receiving, at the server, a selection of the game instance from the client device;
assigning, at the server, a game table to the player, and connecting the client device to the game table;
receiving, at the server, a start signal from the head table; and
communicating, by the server, the start signal to each of the client devices connected to the game tables, wherein the start signal activates gameplay for a round.

29. The method according to claim 28 comprising receiving, at the server, gameplay information from the clients connected to the head table, and in response to receiving the gameplay information, determining scores of the players at the head table based on the gameplay information, and communicating an end signal to each of the clients connected to the game tables if the cumulative score of the players at the head table reaches a threshold value, wherein the end signal deactivates a gameplay for a round.

30. The method according to claim 29 wherein the server communicates the end signal to each of the clients connected to the game tables if a predetermined time interval from the start time of the round has lapsed.

31. The method according to claim 30 comprising, after communicating the end signal, receiving, at the server, gameplay information from the plurality of game tables, and in response to receiving the gameplay information, determining a score of each player at the game tables and ranking the players at each table based on their scores in the round, and moving at least some of the players in each game table up or down a relative rank in table based on the player's ranking.

32. The method according to claim 31 wherein the determination of the game table assignment at the server is based on the player's ranking in a previous round of the game play.

33. The method according to claim 31 wherein the determination of the game table assignment at the server at the start of the game play is based on the time at which the client device transmits the game play selection to the server relative to other client devices.

34. A multi-player management system for implementing a multi-player dice game, comprising a game server connected to a communications network, the server configured to:
transmit game instructions to a client device connected to the network to enable the client device to access the game over the network, wherein the client device is associated with a player;
create a plurality of game tables running on the server, wherein one of the game tables is designated as a head table and wherein the plurality of game tables is associated with an instance of a game;
receive a selection of the game play from the client device;
determine a game table assignment for the player;
assign the player to the game table associated with the game table assignment;
connect the client device to the game table associated with the game table assignment;
receive a start signal from the head table; and
communicate the start signal to each of the client devices connected to the other game tables, wherein the start signal activates gameplay for a round.

35. The system according to claim 34 wherein the server is configured to receive gameplay information from the clients connected to the head table, and in response to receiving the gameplay information, determines scores of the players at the head table based on the gameplay information, and communicates an end signal to each of the clients connected to the game tables if the cumulative score of the players at the head table reaches a threshold value, wherein the end signal deactivates a gameplay for a round.

36. The system according to claim 35 the server is configured to communicate the end signal to each of the clients connected to the game tables if a predetermined time interval from the start time of the round has lapsed.

37. The system according to claim 36 wherein after the server communicates the end signal, the server is configured to receive game play information from the client devices connected to the plurality of game tables, and in response to the game play information, to determine a score of each player at the other game tables and to rank the players at each table based on their scores in the round, and to move at least some of the players in each game table up or down a relative rank in table based on the player's ranking.
